(19) United States
(12) Patent Application Publication
(10) Pub. No.: US 2026/0032531 A1
(43) Pub. Date: Jan. 29, 2026

(54) Activated-Deactivated Conditional Reconfigurations

(71) Applicant: Telefonaktiebolaget LM Ericsson (publ), Stockholm (SE)

(72) Inventors: Alessio Terzani, Stockholm (SE); Pontus Wallentin, Linköping (SE); Cecilia Eklöf, Täby (SE); Jens Bergqvist, Linköping (SE)

(21) Appl. No.: 18/994,982

(22) PCT Filed: May 29, 2023
(86) PCT No.: PCT/SE2023/050520

§ 371 Date: Jan. 15, 2025

Related U.S. Application Data
(60) Provisional application No. 63/359,713, filed on Jul. 8, 2022.

(51) Int. Cl. H04W 36/00; H04W 36/36

(52) U.S. Cl. CPC H04W 36/0069; H04W 36/0058; H04W 36/362

(57) ABSTRACT

A network node (1300) configures an activation status of a conditional reconfiguration within a User Equipment, UE (110) connected to a network via Dual Connectivity (DC) or Multi-Connectivity (MC). The activation status supports an activated state and a deactivated state. The conditional reconfiguration defines a reconfiguration of the UE (110) that is to be performed in response to a set of one or more conditions being fulfilled. The UE (110) deactivates the conditional reconfiguration in response to an event. The CE (110) refrains from performing the reconfiguration when the set of conditions is fulfilled while the conditional reconfiguration is deactivated.

This application claims the benefit of U.S. Provisional Application No. 63/359,713, filed 8 Jul. 2022, the entire disclosure of which is hereby incorporated by reference herein.

### TECHNICAL FIELD

The present disclosure generally relates to the field of wireless communication networks and, more particularly, to efficiently performing reconfiguration of a UE wirelessly connected to the network via a plurality of access nodes.

### BACKGROUND

The Third Generation Partnership Project (3GPP) is a standards organization that produces technical specifications relating to mobile telecommunications. A 3GPP “Release” defines a bundle of specifications that define a stable platform for implementing features in a standard way. In 3GPP Release 12 (Rel-12), the Long Term Evolution (LTE) feature Dual Connectivity (DC) was introduced. DC enables a User Equipment (UE) to be connected in two cell groups, each controlled by an LTE access node, i.e., an eNodeB (eNB), one of which is referred to as the Master eNB, MeNB and the other of which is referred to as the Secondary eNB (SeNB). Despite using DC, the UE nonetheless has only one Radio Resource Control (RRC) connection with the network.

Since Rel-12, a variety of new network deployment scenarios have been developed. For example, DC has evolved and is now also specified for New Radio (NR) as well as between LTE and NR. Multi-connectivity (MC) is similar to DC but involves more than two access nodes. With the introduction of 5G, the term Multi-Radio Dual Connectivity (MR-DC) was defined as a generic term for all dual connectivity options that include at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Moreover, when dual connectivity is configured for the UE in MR-DC, carrier aggregation may also be used within each of the two cell groups (i.e., within the MCG and in the SCG). Indeed, the numerous ways in which a network can be deployed in accordance with 3GPP standards has increased substantially both in number and complexity since Rel-12. As the number of nodes involved in DC or MC scenarios increase, UE reconfiguration procedures potentially impose a higher burden on the network as shifting network conditions, UE mobility, and other factors may cause these nodes to become suboptimal with greater frequency relative to earlier, more simplistic connectivity scenarios.

### SUMMARY

Embodiments of the present disclosure enable activation and deactivation of a conditional reconfiguration. For example, in some embodiments, a UE determines whether to activate or deactivate a stored conditional reconfiguration upon mobility to another cell. When a conditional reconfiguration is deactivated, the UE keeps the reconfiguration stored but does not evaluate whether the execution conditions associated therewith are met.

Embodiments of the present disclosure include a method performed by a User Equipment (UE) connected to a network via Dual Connectivity (DC) or Multi-Connectivity (MC). The method comprises deactivating a conditional reconfiguration in response to an event. The conditional reconfiguration defines a reconfiguration of the UE that is to be performed in response to a set of one or more conditions being fulfilled. The method further comprises refraining from performing the reconfiguration when the set of conditions is fulfilled while the conditional reconfiguration is deactivated.

In some embodiments, the method further comprises, responsive to deactivating the conditional reconfiguration, refraining from evaluating whether the set of conditions is fulfilled for as long as the conditional reconfiguration continues to be deactivated.

In some embodiments, the method further comprises evaluating whether the set of conditions is fulfilled while the conditional reconfiguration is deactivated.

In some embodiments, the method further comprises activating the conditional reconfiguration and performing the reconfiguration responsive to the set of conditions being fulfilled.

In some embodiments, the method further comprises receiving, from the network, the conditional reconfiguration and an indication of whether to treat the conditional reconfiguration as activated or deactivated upon receipt.

In some embodiments, the method further comprises switching an activation state of the conditional reconfiguration depending on whether or not an indication from the network is present, where switching the activation state comprises switching between an activated state and a deactivated state.

In some embodiments, the method further comprises receiving, from the network, a configuration message comprising a type and a state, the state being either activated or deactivated. The method further comprises setting, for one or more conditional reconfigurations stored at the UE, each of the conditional reconfigurations that matches the type to the state comprised in the configuration message.

In some embodiments, the event comprises a mobility procedure performed by the UE. The method further comprises receiving, from the network in advance of the mobility procedure, an indication specifying that the conditional reconfiguration is to be deactivated upon performing the mobility procedure. The method further comprises the deactivating of the conditional reconfiguration in response to the mobility procedure is in accordance with the indication.

In some embodiments, the event comprises reception, from the network, of a configuration message together with an indication. The configuration message configures the performance of the mobility procedure by the UE. The indication indicates to deactivate the conditional reconfiguration in response to the mobility procedure.

In some embodiments, the event comprises the conditional reconfiguration unmapped to particular measurement configuration parameter.

In some embodiments, the event comprises a mobility procedure, performed by the UE, that involves a target cell belonging to a set of one or more cells for which the conditional reconfiguration is to be deactivated.

In some embodiments, the event comprises a mobility procedure, performed by the UE, that involves a target cell having a Radio Access Technology of a particular type.

In some embodiments, the event comprises a mobility procedure, performed by the UE, that involves a target cell having a particular configured state.

In some embodiments, the event comprises a conditional handover procedure having a configuration comprising a Conditional Primary Secondary Cell (PSCell) Addition (CPA) configuration or a Conditional PSCell Change (CPC) configuration.

In some embodiments, the event comprises a having activated or deactivated the conditional reconfiguration more than a threshold number of times in response to previous mobility procedures.

In some embodiments, the event comprises more than a threshold amount of time elapsing since having received the conditional reconfiguration from the network.

In some embodiments, the event comprises a condition in the set being unfulfilled.

In some embodiments, the method further comprises activating the conditional reconfiguration responsive to a condition in the set being fulfilled.

In some embodiments, the event comprises the UE being more than a threshold distance from a reference location.

In some embodiments, the method further comprises performing a different reconfiguration of the UE associated with a further conditional reconfiguration responsive to a further set of one or more conditions being fulfilled. The event comprises receiving an indication from the network in response to performing the different reconfiguration.

In some embodiments, the method further comprises performing random access toward a target cell in the network. The event comprises receiving a Radio Resource Control message indicating that the conditional reconfiguration is to be deactivated.

Other embodiments include a method performed by a network node. The method comprises configuring an activation status of a conditional reconfiguration within a UE connected to a network via DC or MC. The activation status supports an activated state and a deactivated state.

In some embodiments, the method further comprises configuring the activation status comprises sending an indication of the activation status to the UE.

In some embodiments, the method further comprises sending the indication of the activation status to the UE comprises sending the indication to the UE while the conditional reconfiguration is already stored at the UE. In some such embodiments, sending the indication of the activation status to the UE comprises sending the indication along with the conditional reconfiguration. In other such embodiments, configuring the activation status comprises changing the activation status of the conditional reconfiguration.

In some embodiments, sending the indication of the activation status comprises sending the conditional reconfiguration to the UE with an unmapped measurement configuration parameter. The unmapped measurement configuration parameter indicates that the activation state is the deactivated state.

In some embodiments, sending the indication of the activation status comprises sending the conditional reconfiguration to the UE with a valid measurement configuration parameter. The valid measurement configuration parameter indicates that the activation state is the activated state.

In some embodiments, the network node is a master node supporting the DC or MC of the UE. In other embodiments, the network node is a secondary node supporting the DC or MC of the UE.

In some embodiments, the network node is a target node specified within the conditional reconfiguration.

In some embodiments, the method further comprises triggering the UE to perform any one of the UE methods described above.

Other embodiments include a UE. The UE comprises interface circuitry configured to connect to a network via DC or MC. The UE further comprises processing circuitry configured to deactivate a conditional reconfiguration in response to an event. The conditional reconfiguration defining a reconfiguration of the UE that is to be performed in response to a set of one or more conditions being fulfilled. The processing circuitry is further configured to refrain from performing the reconfiguration when the set of conditions is fulfilled while the conditional reconfiguration is deactivated.

In some embodiments, the processing circuitry is further configured to perform any of the UE methods described above.

Yet other embodiments include a computer program comprising instructions that, when executed on processing circuitry of a UE, cause the UE to carry out any one of the UE methods described above.

Still other embodiments include a carrier containing said computer program. The carrier is one of an electronic signal, optical signal, radio signal, or computer readable storage medium.

Other embodiments include a network node. The network node comprises interface circuitry configured to exchange communication signals with a User Equipment (UE). The UE is connected to a network via DC or MC. The network node further comprises processing circuitry configured to configure an activation status of a conditional reconfiguration within the UE. The activation status supports an activated state and a deactivated state.

In some embodiments, the processing circuitry is further configured to perform the method according to any one of the network node methods described above.

Other embodiments include a computer program comprising instructions that, when executed on processing circuitry of a network node, cause the network node to carry out any one of the network node methods described above.

Yet other embodiments include a carrier containing said computer program. The carrier is one of an electronic signal, optical signal, radio signal, or computer readable storage medium.

### BRIEF DESCRIPTION OF THE DRAWINGS

FIG. 1 is a logical block diagram schematically illustrating an example dual connectivity scenario that includes carrier aggregation according to one or more embodiments of the present disclosure.

FIG. 2 is a logical block diagram schematically illustrating an example E-UTRAN-DC (EN-DC) connectivity scenario, according to one or more embodiments of the present disclosure.

FIG. 3 is a logical block diagram schematically illustrating an example of NR-DC connectivity scenario, according to one or more embodiments of the present disclosure.

FIG. 4 is a signaling diagram illustrating example signaling for performing Conditional Handover (CHO), according to one or more embodiments of the present disclosure.

FIG. 5 is a signaling diagram illustrating example signaling for configuring an inter-SN Conditional PSCell Change (CPC), according to one or more embodiments of the present disclosure.

FIG. 6 is a state diagram illustrating state transitions of a Secondary Cell Group (SCG), according to one or more embodiments of the present disclosure.

FIG. 7 is a logical block diagram schematically illustrating an example network arrangement, according to one or more embodiments of the present disclosure.

FIG. 8 is a flow diagram illustrating an example method performed by a UE, according to one or more embodiments of the present disclosure.

FIG. 9 is a flow diagram illustrating an example method performed by a network node, according to one or more embodiments of the present disclosure.

FIG. 10 is a block diagram schematically illustrating an example UE, according to one or more embodiments of the present disclosure.

FIG. 11 is a block diagram schematically illustrating an example network node, according to one or more embodiments of the present disclosure.

FIGS. 12-15 are ASN.1 code snippets illustrating example definitions of Information Elements (IEs), according to one or more embodiments of the present disclosure.

FIG. 16 is an ASN.1 code snippet illustrating an example message definition, according to one or more embodiments of the present disclosure.

### DETAILED DESCRIPTION

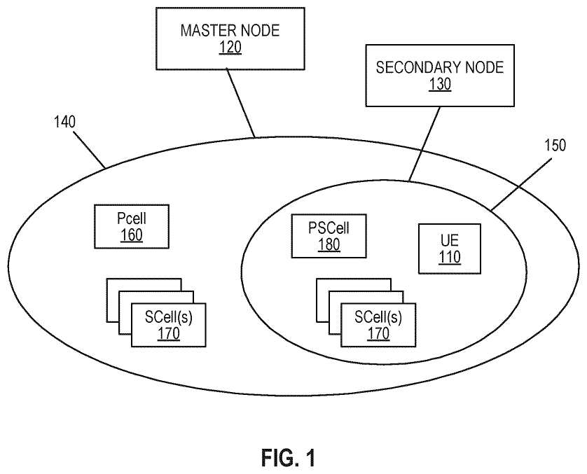

FIG. 1 illustrates an example of dual connectivity combined with carrier aggregation as found in certain traditional MR-DC scenarios. As shown in FIG. 1, within the MCG 140 the UE 110 may use one Primary Cell (PCell) 160 and one or more Secondary Cells (SCells) 170. Additionally, within the SCG 150 the UE 110 may use one Primary SCell (PSCell) 180 (also known as the Primary SCG Cell in NR) and one or more SCells. In NR, the primary cell of a master or secondary cell group is sometimes also referred to as the Special Cell (SpCell). Thus, in an MCG 140 the SpCell is the PCell 160 and in an SCG 150 the SpCell is the PSCell 180.

There are different ways to deploy a 5G network. 5G deployment scenarios can, for example, be performed with or without interworking with LTE (also referred to as Evolved Universal Mobile Telecommunications System (UMTS) Terrestrial Radio Access (E-UTRA)) and the Evolved Packet Core (EPC) 210. In principle, NR and LTE can be deployed without any interworking. An NR network that is deployed without interworking with an LTE network is commonly referred to as NR stand-alone (SA) operation. NR SA is also commonly known as Option 2. Option 2 is in contrast to Option 1, which involves an eNB in LTE that is connected to an EPC 210 without interworking with NR. In other words, an NR access node (i.e., a gNodeB (gNB)) can be connected to a 5G Core Network (5GC) 220 (i.e., Option 2) and an eNB in LTE can be connected to EPC 210 (i.e., Option 1) with no interconnection between the two.

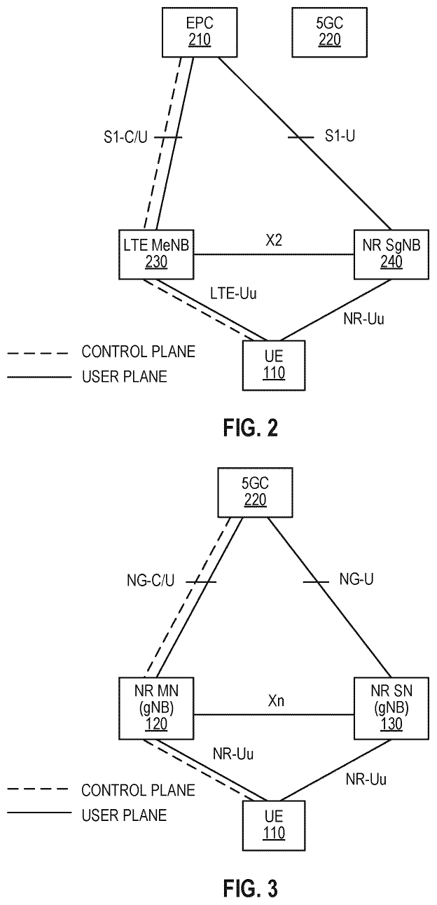

There are other deployment options available beyond Options 1 and 2. For example, the first supported version of NR uses dual connectivity commonly referred to as E-UTRA Network (E-UTRAN)-NR Dual Connectivity (EN-DC), which is also known as Option 3. An example of an Option 3 deployment is depicted in FIG. 2. In an EN-DC deployment, dual connectivity between NR and LTE is applied such that the UE 110 is connected with both the LTE radio interface (e.g., the LTE Uu interface) to an LTE access node and the NR radio interface (e.g., the NR Uu interface) to an NR access node. Further, in EN-DC, the LTE access node acts as the MN 120 (in this case, the Master eNB (MeNB) 230) controlling the MCG 140 and the NR access node acts as the SN 130 (in this case, the Secondary gNB (SgNB) 240) controlling the SCG 150. The SgNB 240 may, in some cases, lack a control plane connection to the EPC 210 (as illustrated in the example of FIG. 2). Instead, a control plane connection is provided by the MeNB 230. The deployment scenario depicted in FIG. 2 is also called Non-standalone NR (NSA NR). Given the control and user plane connections provided by such a deployment, the functionality of an NR cell is limited and would traditionally be used for connected mode UEs simply as a booster and/or diversity leg. A UE 110 in the RRC_IDLE state traditionally cannot camp on these NR cells.

With introduction of 5GC 220, other deployment options may also be valid. As mentioned above, Option 2 supports stand-alone NR deployment in which a gNB is connected to a 5GC 220. Similarly, LTE can be connected to a 5GC 220 using Option 5. Option 5 is also sometimes referred to as Enhanced LTE (eLTE), E-UTRA/5GC, or LTE/5GC. The access node in an Option 5 deployment may be referred to as a Next Generation eNB (ng-eNB). In Option 2 and in Option 5, NR and LTE are seen as part of the Next Generation Radio Access Network (NG-RAN). Correspondingly, both the ng-eNB and the gNB can be referred to as NG-RAN nodes.

There are also other variants of dual connectivity between LTE and NR which have been standardized as part of an NG-RAN connected to a 5GC 220. Other deployments under the MR-DC umbrella include EN-DC (discussed above), NR-E-UTRA DC (NE-DC), NG-RAN-E-UTRA-NR DC (NGEN-DC), and NR-DC.

As mentioned above and as depicted in FIG. 2, in EN-DC (Option 2) the MN 120 is an LTE node and the SN 130 is an NR node and an EPC 210 is employed.

In NE-DC (also known as Option 4), the MN 120 is an NR node, the SN 130 is an LTE node, and a 5G Core Network (5GCN) is employed.

In NGEN-DC (also known as Option 7), the MN 120 is an LTE node, the SN 130 is an NR node, and a 5GCN is employed.

NR-DC (which is a variant of Option 2) involves dual connectivity where both the MN 120 controlling the MCG 140 and the SN 130 controlling the SCG 150 are NR, with a 5GCN being employed (as depicted in FIG. 3).

In 3GPP Rel-16, a mechanism known as Conditional Handover (CHO) was standardized as a solution to increase robustness at handover. In order to avoid the undesired dependence of the serving radio link upon the time and radio conditions in which the UE 110 should execute the handover, the ability to provide RRC signaling for the handover to the UE 110 at an earlier time was standardized. Under this standardized solution, it is possible to associate a handover (HO) command with a condition, e.g., based on radio conditions (possibly similar to those associated with an A3 event). For example, an HO command may be associated with a given neighbor node being some number of decibels better than a target node. When the condition is fulfilled, the UE 110 can execute the handover in accordance with the provided handover command.

Such a condition could, e.g., be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration message with mobilityControlInfo (or the RRCReconfiguration message with reconfigurationWithSync) at a time when the radio link between the source cell and the UE 110 is still stable. The execution of the handover is done at a later point in time (and threshold), which is traditionally considered optimal for the handover execution.

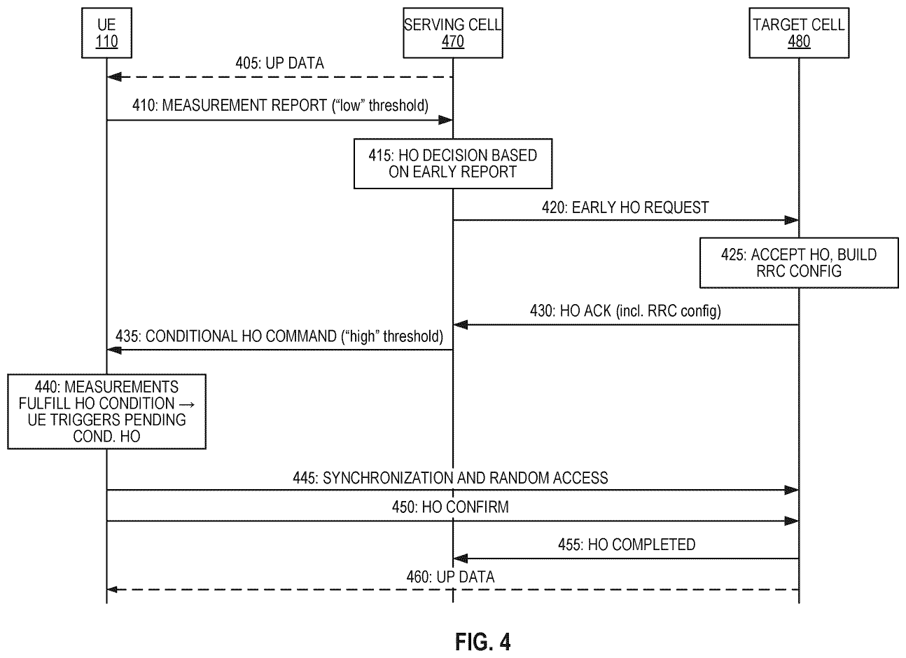

FIG. 4 depicts an example of CHO execution that includes a serving cell 470 and a target cell 480. In practice, there may often be many cells or beams that the UE 110 has reported as possible candidates based on its preceding Radio Resource Management (RRM) measurements (step 410). The network should then have the freedom to issue conditional handover commands for several of those candidates (step 435). The RRCConnectionReconfiguration (or RRCReconfiguration) message for each of those candidates may differ not just concerning the target cell 480 but also, e.g., in terms of the HO execution condition (RS to measure and threshold to exceed) as well as in terms of the RA preamble to be sent when a condition is met.

While the UE 110 evaluates the condition, it continues operating per its current RRC configuration, i.e., without applying the conditional HO command. When the UE 110 determines that the condition is fulfilled (step 440), it disconnects from the serving cell 470, applies the conditional HO command and connects to the target cell 480. These steps are equivalent to the legacy handover execution.

When the UE 110 has successfully performed the random access procedure towards the target cell 480 during a conditional handover or a normal handover (step 445), it then releases all the conditional reconfigurations that it has stored. The target cell 480 may then configure new conditional reconfigurations to the UE 110 if it is considered useful.

A solution for Conditional PSCell Change (CPC) was also standardized in Rel-16. According to this solution, a UE 110 operating in MR-DC receives in a conditional reconfiguration one or more RRC Reconfigurations (e.g., an RRCReconfiguration message) containing an SCG configuration (e.g. an secondaryCellGroup of Information Element (IE) CellGroupConfig) with a reconfigurationWithSync that is stored and associated with an execution condition (e.g., a condition such as that found in an A3/A5 event configuration). In this way, a stored message may be applied upon fulfillment of the associated execution condition. This may be used in association with the serving PSCell 180 to trigger the UE 110 to perform a PSCell 180 change (e.g., if the UE 110 finds a neighbor cell that is better than the current SpCell of the SCG 150). Only intra-SN CPC without MN 120 involvement is standardized in 3GPP Rel-16, i.e. for cases where the (candidate) target PSCells are located in the current serving SN 130.

Similar to conditional handover, if a random access was performed for a target PSCell and the UE 110 was configured with CPC, the UE 110 releases all the conditional reconfigurations that it has stored according to the standardized procedure.

In 3GPP Rel-17, solutions for Conditional PSCell Addition (CPA) and inter-SN CPC are being discussed and introduced. The CPA procedure is used for adding a PSCell 180/SCG 150 to the configuration for a UE 110 that is currently only configured with an MCG 140 when associated execution conditions are fulfilled. CPA is initiated by the MN 120 by requesting an SCG configuration from a (candidate) target SN (T-SN). The SCG configuration is sent in a conditional reconfiguration to the UE 110 together with the associated execution conditions.

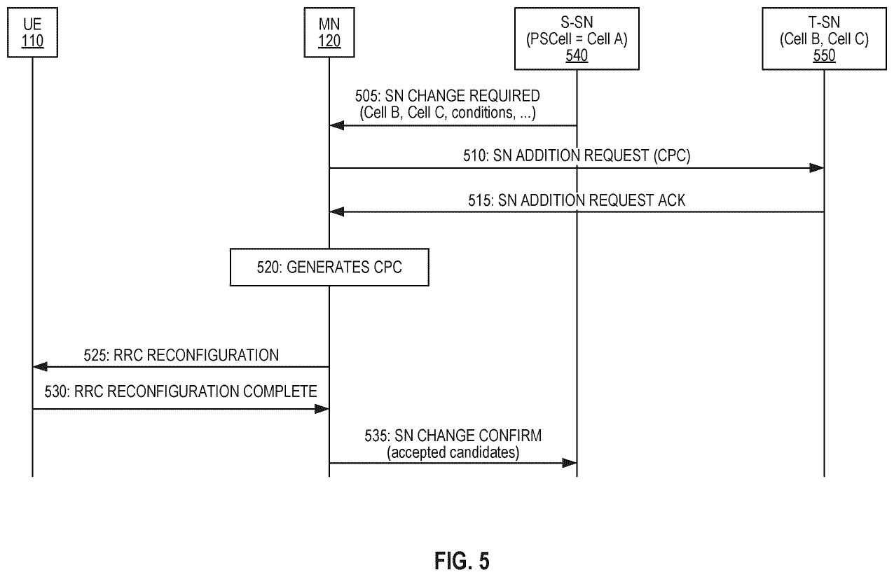

One of the possible signaling sequences for configuration of an inter-SN CPC can be seen in the example signaling flow illustrated in FIG. 5. In this example, inter-SN CPC is initiated by the source SN (S-SN) 540 (step 505). In other examples, the inter-SN CPC can be initiated by the MN 120. Signaling towards the S-SN 540 (step 535) and the (candidate) target SNs (T-SNs) 550 (step 510), as well as towards the UE 110 (step 525), is handled by the MN 120.

Also, for Rel-17 CPC/CPA, it can be expected that the UE 110 configured with CPC/CPA has to release the CPC/CPA configurations when completing random access towards the target PSCell.

For 3GPP Rel-18 work is commencing that intend to introduce enhancements for different mobility procedures. One of the current objectives is to specify an NR-DC mechanism and procedures with selective activation of the cell groups (at least for SCG 150) via L3 enhancements. This includes allowing a subsequent cell group change after changing CG without reconfiguration and re-initiation of CPC/CPA.

It should thus be possible to perform a subsequent cell group change after a first cell group change, without reconfiguring or re-initiating CPC or CPA. This would then be done in order to reduce the interruption time and the signaling overhead for SCG 150 changes, especially when frequent SCG 150 changes occur when operating in Frequency Range 2 (FR2) in NR as compared to when these configurations are released upon UE 110 completion of random access towards the target PSCell (i.e., as in the previous releases).

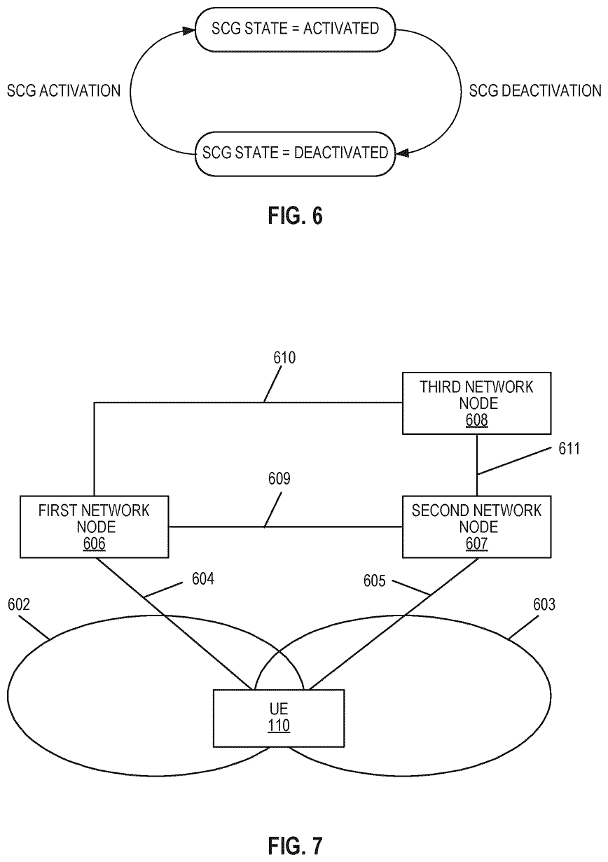

The 3GPP has, in Rel-17, developed solutions for the Rel-17 MR-DC work item objective of supporting an efficient activation/deactivation mechanism for one SCG 150 and SCells 170. As part of this objective, the concept of a “deactivated SCG” with an aim to save power when traffic demands are dynamically reduced is being discussed. As FIG. 6 also illustrates, there are two SCG states (sometimes referred to as states for SCG activation or states for PSCell activation) being discussed. These states are referred to as a “deactivated” SCG state and an “activated” SCG state. These states concern the power saving mode for the SCG 150 and should not be confused with the RRC states.

During the deactivated SCG state, or sometimes referred to as when “SCG is deactivated”, or a deactivated PSCell state, 3GPP RAN2 has, for example, agreed to the following:
RRC configuration can select SCG activation state.
No PDCCH/PDSCH/PUSCH Tx/Rx on PSCell
All SCells are deactivated
SCG reconfiguration via MCG is supported
RRM & PSCell mobility is supported.
Both RACH and RACH-less SCG activation supported
UE keeps Time Alignment timer running
UE continues BFD/RLM (if configured)
SCG activation indication can indicate TCI state

Despite these numerous advances, traditional techniques have handled conditional reconfiguration information poorly after a cell change or handover has been performed. According to traditional techniques, when a UE 110 receives one or more conditional reconfigurations in a first cell (C1) and keeps them stored after performing a cell change/handover to another cell (C2), it is unclear how the UE 110 should behave. In particular, it is unclear whether or not the UE 110 should evaluate the conditions for the stored configurations. For example, the likelihood that the reconfiguration conditions will be fulfilled are likely to be quite low if the cell to be evaluated is far from the one where the UE 110 is currently located. In this case, evaluating the reconfiguration conditions would cause unnecessary UE 110 processing and, correspondingly, power consumption.

Alternatively, the network could release all the conditional reconfigurations that are not relevant. However, doing so would cause the UE 110 to require reconfiguration again should the UE 110 enter an area where those conditional reconfigurations would have been relevant. Thus, releasing all of the conditional reconfigurations may result in an increase in signaling overhead and/or may increase the delay for the subsequent cell change, especially in the case of frequent SCG 150 changes when operating in FR2.

In view of the above, embodiments of the present disclosure provide techniques for activating and deactivating a conditional reconfiguration. When a conditional reconfiguration is deactivated, the UE 110 keeps the conditional reconfiguration stored but does not perform any evaluation of the execution conditions. As an alternative, the UE 110 may evaluate the execution conditions but not trigger execution of the associated reconfiguration while the conditional reconfiguration is deactivated. Whether a conditional reconfiguration is deactivated or activated may, in some embodiments, be controlled by the network.

Embodiments also include different methods for a UE 110 and network to determine whether a stored conditional configuration shall be activated or deactivated after execution of a mobility procedure (e.g. after a successful random access procedure to the target SpCell at a handover, PSCell change, or addition procedure). Depending on the embodiment, the UE 110 may activate or deactivate the stored conditional configuration associated with a target candidate based on one or more criteria. These criteria may be based on, individually or in any combination:
an indication within the conditional reconfiguration or an associated indication;
identification of which target cell the mobility procedure is executed for (e.g., whether or not the target cell for which the mobility procedure is executed is part of a certain set of cells);
the type of mobility procedure executed (e.g., whether the mobility procedure is a handover, PSCell change, or PSCell addition procedure)
a cause of the mobility procedure (e.g., whether the mobility procedure is executed due to applying a conditional reconfiguration or due to a network indication);
the type of conditional reconfiguration being considered for activation or deactivation (e.g., whether the conditional reconfiguration is a Conditional Handover, Conditional PSCell Addition, or Conditional PSCell Change configuration).
the type of conditional reconfiguration to be applied if the condition is met (i.e., if the conditional reconfiguration includes another conditional reconfiguration, taking the type of that included reconfiguration into account);
behavior performed if a conditional reconfiguration is either kept or released (e.g., if the conditional reconfiguration is determined to be kept, it is always kept activated (or deactivated)).
the number of consecutive mobility procedures that have been executed with the active conditional reconfiguration stored (e.g., a stored conditional reconfiguration may be deactivated after a certain number of mobility procedures that have been executed with the conditional configuration stored). This number, in particular, may be based on the type of executed mobility procedure and/or that it is a stored conditional reconfiguration that has been applied or executed;
the elapsed time since the active conditional reconfiguration was stored relative to a configured threshold;
the configured state of the target cell within the conditional reconfiguration (e.g., whether a CPA or CPC configuration includes a target PSCell/SCG that is configured to be activated or deactivated after execution of the PSCell addition and PSCell change procedure, respectively);
whether an execution condition in a conditional reconfiguration is fulfilled (e.g., that an entry or exit condition for a certain conditional event is fulfilled); and/or
the distance between the UE and a configured reference location relative to a configured threshold.

Embodiments also include different methods for a network node to configure a UE 110 to consider a conditional reconfiguration as being activated or deactivated. In some embodiments, such configuration of the UE 110 may be performed at initial configuration of the conditional reconfiguration or at execution of a mobility procedure. In some embodiments, the configuration of the UE 110 may be to indicate to the UE 110 (e.g., as part of, or after, the execution of a mobility procedure) what conditional reconfigurations to activate or deactivate. Methods for the UE 110 to indicate to the network that it is capable of activate/deactivate conditional reconfigurations are also described herein.

Particular embodiments may provide one or more technical advantages. For example, by disabling a conditional reconfiguration that is no longer relevant, a UE 110 may avoid the processing required to evaluate the conditions associated therewith. By reducing UE 110 processing, UE 110 power may be conserved.

Additionally or alternatively, by keeping a conditional reconfiguration stored after a mobility event despite being deactivated, the UE 110 and the network may avoid having to reestablish the conditional reconfiguration upon becoming relevant again. That is, less signaling over the network is required to inform the UE 110 to enable a deactivated configuration reconfiguration than is required to retransmit it over the downlink to the UE 110. Other advantages may additionally or alternatively be gleaned from particular embodiments as will be discussed in, or apparent from, the disclosure below.

It should be noted that this disclosure may refer to a first network node operating as an MN 120 (e.g., which belongs to an MCG 140 configured to the UE 110). Such an MN 120 can be any network node and/or network function that fulfills the role of the MN 120 discussed herein. Particular examples of an MN 120 according to particular embodiments include a gNB, a Central Unit gNB (CU-gNB), an eNB, and/or a Central Unit eNB (CU-eNB).

This disclosure may also refer to a second network node operating as an SN 130 or S-SN 540 (e.g., belonging to an SCG 150) pre-configured to support the UE 110. Such an MN 120 can be any type of network node and/or network function that fulfills the role of a SN 130 discussed herein. Particular examples of an SN 130 according to particular embodiments include a gNB, a CU gNB, an eNB, and/or a CU-eNB. The MN 120, S-SN 540, and T-SN 550 may be from the same RAT or from different RATs depending on the embodiment. The MN 120, S-SN 540, and T-SN 550 may additionally or alternatively be associated with the same CN or with different CNs, depending on the embodiment.

The present disclosure may refer to a target SN. This should be understood to mean that the node is a target candidate SN or a network node associated to a target candidate PSCell that is being configured. If the UE 110 would connect to that cell, transmissions and receptions with the UE 110 would be handled by that node if the cell is associated to that node.

The present disclosure may also refer to a cell that “resides” in a node (e.g., a target candidate cell resides in the S-SN 540 or the T-SN 550). This should be understood to mean that a cell is managed by, associated with, or belongs to the node.

“SN-initiated CPC” refers to a procedure in which the Source SN for a UE 110 configured with MR-DC determines that it will configure CPC. Upon determining that it will configure CPC, the Source SN selects (e.g., based on reported measurements), one or more target candidate cells (e.g., target candidate PSCell(s)). At least one cell is associated to the Source SN and at least another cell is associated to a neighbor SN. It can be said that if all target candidate cells are associated to the Source SN, that is an “SN-initiated intra-SN CPC.” This may also be referred to as a Rel-16 solution. If at least one target candidate cell is associated to a neighbor SN, that may be referred to as an “SN-initiated inter-SN CPC”, which may also be referred as a Rel-17 solution.

The present disclosure may refer to a candidate SN, or SN candidate, or an SN 130, as the network node (e.g., gNB) that is prepared during the CPA procedure and that can create an RRC Reconfiguration message with an SCG configuration (e.g., RRCReconfiguration) to be provided to the UE 110 and stored, with an execution condition. The UE 110 only applies the message upon the fulfillment of the execution condition. That candidate SN is associated to one or multiple PSCell candidate cells that the UE 110 can be configured with. The UE 110 then can execute the condition and accesses one of these candidate cells, associated to a candidate SN that becomes the SN 130 or simply the SN 130 after execution (i.e., upon fulfillment of the execution condition).

The present disclosure may refer to a CPC configuration and CPC procedures (e.g., CPC execution). In general, such references refer to the procedure from the UE 110 perspective.

Other terms may be considered as synonyms. These terms include the phrase conditional reconfiguration and conditional configuration, given that the message that is stored and applied upon fulfillment of a condition is an RRCReconfiguration or RRCConnectionReconfiguration.

Terminology wise, one could also interpret CHO in a broader sense to also cover CPA procedures. The present disclosure refers to a Conditional SN Change most of the time with respect to the procedure from the UE 110 perspective, i.e., to refer to procedures between network nodes wherein a node requests a target candidate SN (which may be the same as the S-SN 540 or neighbor SN) to configure a CPC for at least one of its associated cells (i.e., a cell associated to a target candidate SN).

The present disclosure uses the term CPAC to refer to either a CPA or a CPC.

The present disclosure also document refers to a neighbor SN and a Source SN as different entities, though both could be a target candidate SN for CPC.

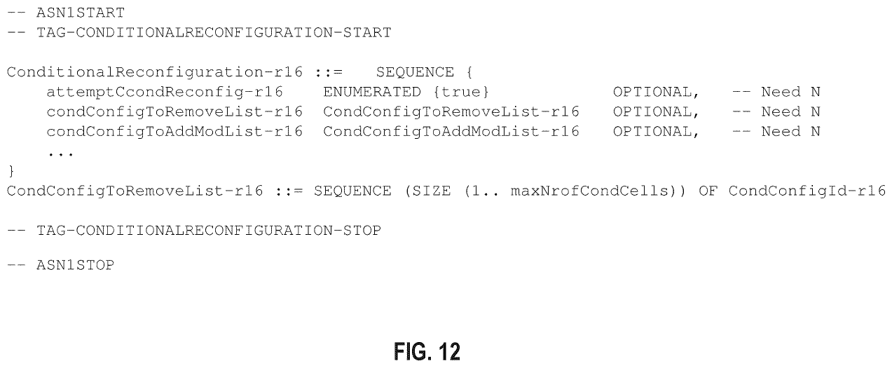

The configuration of CPC can be done in particular embodiments using the same IEs as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs may, e.g., be as provided in TS 38.331 or as provided in FIGS. 12-14.

FIG. 12 is an example ASN.1 code snippet of a ConditionalReconfiguration IE, which may be used to add, modify and release the configuration of conditional configuration. The field condConfigToAddModList is a list of the configuration of candidate SpCells to be added or modified for CHO or CPC. The field condConfigToRemoveList is a list of the configuration of candidate SpCells to be removed. When the network removes the stored conditional configuration for a candidate cell, the network releases the measIDs associated to the condExecutionCond if it is not used by the condExecutionCond of other candidate cells.

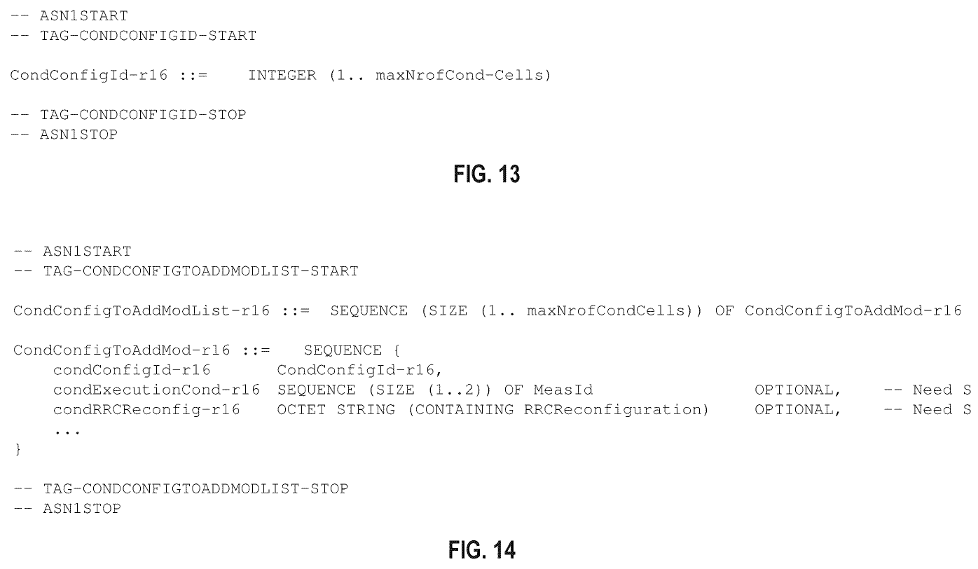

FIG. 13 is an example ASN.1 code snippet of the CondConfigId IE, which may be used to identify a CHO or CPC configuration.

FIG. 14 is an example ASN.1 code snippet of the ConfigToAddModList IE, which concerns a list of conditional configurations to add or modify and, for each entry, the CondConfigId and the associated condExecutionCond and condRRCReconfig. The condExecutionCond field is the execution condition that needs to be fulfilled in order to trigger the execution of a conditional configuration. The field's presence is mandatory when a condConfigId is being added. Otherwise, when the condRRCReconfig associated to a condConfigId is being modified it is optionally present and the UE 110 uses the stored value if the field is absent.

The condRRCReconfig field is the RRCReconfiguration message to be applied when the condition(s) are fulfilled. The field's presence is mandatory when a condConfigId is being added. Otherwise, when the condExecutionCond associated to a condConfigId is being modified it is optionally present and the UE 110 uses the stored value if the field is absent.

Embodiments of the present disclosure refer to a UE 110 that activates or deactivates a conditional reconfiguration upon configuration of the conditional reconfiguration (i.e., when the conditional reconfiguration is received from the network) and/or at execution of a mobility procedure. The mobility procedure that is executed may correspond to (but is not restricted to) a conditional reconfiguration, e.g., a CHO, a CPC, a CPA procedure, or a corresponding non-conditional mobility procedure (e.g., a handover, a PSCell change, or a PSCell addition). The mobility procedure may additionally or alternatively correspond to another type of reconfiguration, such as addition, modification, or release of a cell group, or of a cell, or of another configuration. The mobility procedure that is executed may alternatively correspond to a change of state for a part of the UE 110 configuration, e.g., a change of state for the SCG 150 where the SCG state is changed from deactivated to activated or from activated to deactivated, or a change of state for one or more SCells 170. The execution of the mobility procedure may include the UE 110 performing a reconfiguration with a sync procedure (either with or without performing a random access procedure towards the (target) cell) or without a sync procedure.

Various embodiments enable activation, deactivation, and/or reactivation of a conditional reconfiguration. When deactivated, the UE 110 does not trigger the reconfiguration regardless of whether or not the associated condition(s) are met. In a particular embodiment, the UE 110 does evaluate the execution conditions for the conditional reconfiguration while it is deactivated. In another embodiment, the UE 110 evaluates the execution conditions for a deactivated conditional reconfiguration but does not trigger execution of the reconfiguration even if the execution conditions are fulfilled.

In some embodiments, activation and deactivation of a conditional reconfiguration are performed in response to an indication received from the network. The UE 110 may additionally or alternatively activate or deactivate a stored conditional reconfiguration responsive to a change to another cell (e.g. after a successful random access procedure to the target SpCell).

In some embodiments, to perform activation or deactivation of a conditional reconfiguration, the UE 110 may determine, based on explicit or implicit information from the network, whether to activate or deactivate a conditional reconfiguration. In some such embodiments, in response to determining that the conditional reconfiguration is to be deactivated, the UE 110 keeps the conditional reconfiguration stored and refrains from evaluating the related execution conditions. Alternatively, in response to determining that the conditional reconfiguration is to be deactivated, the UE 110 evaluates the execution conditions for the conditional reconfiguration and refrains from executing the associated configuration when the execution conditions are fulfilled.

In some embodiments, if the conditional reconfiguration is activated, the UE 110 evaluates the execution conditions and triggers execution of the associated configuration responsive to the execution conditions being fulfilled.

In some embodiments, the UE 110 receives an indication from the network together with (e.g., comprised within) the conditional reconfiguration whether that conditional reconfiguration should be considered to be deactivated or activated upon reception. When receiving the conditional reconfiguration with the indication that it is deactivated, the UE 110 then considers the conditional reconfiguration as being deactivated. This is then valid until the UE 110 receives an indication to activate the conditional reconfiguration (i.e. a new indication that corresponds to that the conditional reconfiguration to be is activated) or an event occurs, which means that the conditional reconfiguration shall be considered as activated.

In some embodiments, the UE 110 receives an indication from the network to change a conditional reconfiguration to be deactivated or to be activated, i.e., so that a stored conditional reconfiguration that is “deactivated” is changed to be “activated” or that a stored conditional reconfiguration that is “activated” is changed to be “deactivated”. The UE 110 may receive the indication from the network to consider one or more conditional reconfiguration(s) to be deactivated or activated using dedicated or broadcast RRC signaling, a Medium Access Control (MAC) Control Element (CE) or Downlink Control Information (DCI). In one example, the indication is included if the conditional reconfiguration is to be considered as deactivated whereas absence of the indication means that the conditional reconfiguration is to be considered as activated.

In some embodiments, the UE 110 receives an indication from the network that a certain type of conditional reconfiguration is to be considered deactivated or activated. The UE 110 then deactivates or activates the conditional reconfigurations of the corresponding type (or types) that it has stored to be deactivated or activated in accordance with the indication from the network. In one example, the network broadcasts an indication (e.g., using system information) that all conditional reconfigurations of a certain type should be considered as deactivated (or activated) in the cell.

In some embodiments, the UE 110 activates or deactivates a conditional reconfiguration based on an explicit indication received from the network before the execution of a mobility procedure. Examples of such a mobility procedure include a handover, a PSCell change, and/or a PSCell addition procedure.

For example, in some such embodiments the UE 110 activates the conditional reconfiguration upon execution of a mobility procedure responsive to the indication being set to a value that indicates that the conditional reconfiguration is to be active. In response, the UE 110 evaluates the associated execution conditions after changing to the target cell (or to the new configuration).

In another example, the UE 110 deactivates the conditional reconfiguration upon execution of the mobility procedure responsive to the indication being set to a value that indicates that the conditional reconfiguration is to be deactivated. In response, the UE 110 keeps the conditional reconfiguration stored and refrains from evaluating the execution conditions associated with the conditional reconfiguration after changing to the target cell.

In another example, the UE 110 deactivates the conditional reconfiguration upon execution of a mobility procedure responsive to an explicit indication from the network being present. Alternatively, the absence of the indication may instead be an indication that the UE 110 shall deactivate the conditional reconfiguration upon execution of the mobility procedure. That is, the UE 110 deactivates the conditional reconfiguration responsive to the indication from the network being absent.

In another example, the UE 110 determines whether to activate or deactivate the conditional reconfigurations jointly with the determining whether to keep or release the conditional reconfigurations. For example, the UE 110 may be configured to activate (or deactivate) a conditional reconfiguration responsive to the UE 110 determining that the conditional reconfiguration is to be kept (i.e., and not discarded).

The indication to activate or deactivate the conditional reconfiguration at execution of a mobility procedure can be included in, or be associated to, the corresponding conditional reconfiguration that is to be activated or deactivated.

In some embodiments, the indication of whether to activate or deactivate the conditional reconfiguration is provided together with (e.g., comprised within) a configuration message for the mobility procedure that is executed. For example, the UE 110 may receive the indication from the network in a message (e.g., an RRC Reconfiguration message) that configures a handover (e.g., a reconfiguration with sync for the MCG 140/PCell 160). In another example, the UE 110 may receive the indication from the network in a message (e.g. an RRC Reconfiguration message) that configures a PSCell change, a PSCell addition, or a release of a PSCell 180/SCG 150.

In some embodiments, the deactivation of the conditional reconfiguration is performed responsive to an execution condition that does not have an associated ReportConfig/MeasObject. For example, the UE 110 may be configured to treat a conditional reconfiguration lacking a mapping measId in the measurement configuration as being deactivated. Correspondingly, the UE 110 may be configured to treat a conditional reconfiguration that includes a mapping measId as being activated.

In some embodiments, the activation/deactivation of the conditional reconfiguration can be done by the network by setting a specific indication included in each conditional reconfiguration.

In some embodiments, the indication of whether to activate or deactivate the conditional reconfiguration is dependent on the target cell of the mobility procedure that is executed. In one example, there are different indications or indication values for different target cells. The indication can then e.g. be provided (or set to a specific value) for a subset of the possible target cells for the mobility procedure that is executed and be absent or set to a different value for another subset of possible target cells. For example, if the target cell is part of a certain set of cells, such as a configured group or cells, or part of an area, such as a registration area, the conditional reconfiguration is activated, otherwise it is deactivated. Or for example, if the target cell is of a same or different RAT than the cell of a certain conditional reconfiguration, the conditional reconfiguration is activated or deactivated.

In some embodiments, the UE 110 determines whether to activate or deactivate a conditional reconfiguration, at execution of a mobility procedure, based on an implicit indication.

In some embodiments, the implicit indication to activate or deactivate a conditional reconfiguration at execution of a mobility procedure, corresponds to the configured state of the target cell within the conditional reconfiguration, e.g., whether a CPA or CPC configuration includes a target PSCell/SCG 150 that is configured to be activated or deactivated after execution of the procedure.

In some embodiments, the implicit indication to activate or deactivate a conditional reconfiguration upon performing a mobility procedure corresponds to whether a certain reconfiguration was performed at the execution of the mobility procedure. For example, whether a certain IE or field is present or absent in the RRC configuration (e.g. an RRC message such as RRCReconfiguration) that was applied during the execution of the mobility procedure. Or for example, whether a certain IE or field was set to a certain value in the RRC configuration (e.g. an RRC message such as RRCReconfiguration) that was applied during the execution of the mobility procedure.

In some embodiments, the UE 110 keeps conditional reconfigurations activated or deactivated depending on the type of conditional reconfiguration that is executed and also what the conditional reconfiguration contained. As an example, the UE 110 keeps other conditional reconfigurations activated (or deactivated) after a CHO has been executed, if the CHO configuration contained CPA or CPC configurations.

In another embodiment, the UE 110 determines when it performs a mobility procedure to activate or deactivate a conditional reconfiguration based on the number of times that conditional reconfiguration has already been activated/deactivated upon execution of mobility procedures.

For example, upon execution of a mobility procedure the UE 110 may check the number of mobility procedures that have already been performed where the conditional reconfiguration has been activated. Responsive to the UE 110 having performed fewer than a threshold number of mobility procedures in which the conditional reconfiguration has been activated, the UE 110 keeps the conditional reconfiguration active. Alternatively, responsive to the UE 110 having performed more than a threshold number of mobility procedures in which the conditional reconfiguration has been activated, the UE 110 deactivates the conditional reconfiguration. This threshold before deactivating the stored conditional reconfigurations can, e.g., be predefined (e.g., in accordance with specifications or hard-coded) or configured by the network to the UE 110 (e.g., via dedicated or broadcast signaling).

In yet another embodiment, the UE 110 determines whether to keep active or deactivate a conditional reconfiguration based on whether more than a threshold amount of time has elapsed since receiving the conditional reconfiguration from the network. The threshold amount of time can, e.g., be predefined (e.g., hard-coded or preconfigured, preferably in accordance with 3GPP specifications if standardized) or configured in the UE 110 by the network (e.g. via dedicated or broadcast signaling). The threshold may, in some embodiments, be different for different conditional reconfigurations. In some embodiments, the threshold for a given conditional reconfiguration can be provided together with (e.g., within) the given conditional reconfiguration from the network.

In some embodiments the UE 110 deactivates a conditional reconfiguration responsive to a threshold amount of time elapsing since that conditional reconfiguration was received by the UE 110. In some embodiments, the UE 110 deactivates a conditional reconfiguration responsive to a mobility procedure being performed and a threshold amount of time elapsing since the UE 110 received the conditional reconfiguration. In some embodiments, the UE 110 activates or deactivates the conditional reconfiguration based on whether the elapsed time is above or below the threshold.

In some embodiments, the UE 110 activates or deactivates a conditional reconfiguration depending on the target cell towards which a cell change or handover procedure is performed. Activation or deactivation of a stored conditional reconfiguration may be different for different target cells such that the conditional reconfiguration is activated for a subset of the potential target cells and deactivated for other potential target cells.

In yet another embodiment, the UE 110 determines whether to activate or deactivate a conditional reconfiguration depending on whether an execution condition in a conditional reconfiguration is fulfilled (e.g., whether an entering or leaving condition for a certain conditional event is fulfilled). For example, if the entering condition for an event A4 (Neighbor becomes better than threshold) is fulfilled, a certain conditional configuration becomes activated. Or for example, if the leaving condition for an event A4 (Neighbor becomes better than threshold) is fulfilled, a certain conditional configuration becomes deactivated.

In yet another embodiment, the UE 110 determines whether to activate or deactivate a conditional reconfiguration based on the distance between UE 110 and a configured reference location is larger or shorter than a configured threshold. For example, if the distance becomes larger than a threshold, the conditional reconfiguration is deactivated. Or for example, if the distance becomes shorter than a threshold, the conditional reconfiguration is activated.

In some embodiments, the UE 110 gets an indication from the network to activate or deactivate a conditional reconfiguration after execution of a mobility procedure, e.g. after execution of another conditional reconfiguration.

In some embodiments, the UE 110 keeps stored but deactivates all the conditional reconfigurations after execution of a mobility procedure, until it receives an indication from the network set to a value that corresponds to the conditional reconfigurations to be activated. After the UE 110 receives the indication from the network to activate the conditional reconfigurations it then starts the evaluation of relevant execution conditions.

In some embodiments the UE 110 continues to perform evaluation of the execution conditions of all the conditional reconfigurations that are active after the execution of a first conditional reconfiguration before receiving an indication from the network (e.g. from a target node of the executed conditional reconfiguration) whether they shall be activated or deactivated. Responsive to the execution conditions being fulfilled before the UE 110 receives an indication from the network, the corresponding conditional reconfiguration may then be triggered.

In some embodiments, the UE 110 receives an indication from a target node of the executed conditional reconfiguration. The indication may, e.g., be received in an RRC message (e.g. an RRC Reconfiguration message or a new RRC message). In one example, the UE 110 gets the indication from the network after successfully performing random access towards the target node/cell of the executed conditional reconfiguration.

In another embodiment the UE 110 provides information to the network that assists in the decision about what conditional reconfigurations that should be activated or deactivated as part of performing or completing the conditional reconfiguration that is executed. In some such embodiments, the information is sent directly to the target MN 120 of the executed conditional reconfiguration (e.g., in case of an executed Conditional Handover procedure). In other such embodiments, the information is sent directly to the target SN of the executed conditional reconfiguration (e.g., in case of an executed Conditional PSCell Change, an executed Conditional PSCell Addition procedure, or a Conditional Handover procedure that includes an SCG configuration). In yet other such embodiments, the information is sent to the MN 120, which then sends the information to the SN 130. In one example, the information is sent together with (e.g., within) an RRC Reconfiguration Complete message that is sent to the network.

The information that is provided by the UE 110 to the network, in order to assist in the decision about what conditional reconfigurations that should be activated or deactivated, may include, e.g., a list of the conditional reconfigurations that the UE 110 has stored, information about the stored conditional reconfigurations, and/or measurement results. The information about the stored conditional reconfigurations may include, e.g., for each of one or more of the stored conditional reconfigurations:
an identity of conditional reconfiguration (e.g., expressed as a CondReconfigID parameter, field, or IE);
an identity/identities of the one or more candidate cells that are included in the conditional reconfiguration, e.g., specified as a frequency and/or Physical Cell Identity (PCI);
the execution conditions for the conditional reconfiguration;
a measurement configuration of the conditional reconfiguration;
a present status of the conditional reconfiguration (e.g., whether the conditional reconfiguration is activated or deactivated); and/or
the type of conditional reconfiguration (e.g. whether it is a CHO, CPA and/or CPC configuration).

The measurement results may comprise, e.g., measurement results for the target cells of the conditional reconfigurations.

In some embodiments, the UE 110 indicates that it supports activation/deactivation of conditional reconfigurations upon execution of a mobility procedure (e.g. upon execution of another conditional reconfiguration) by providing the above-described assistance information to the network. The provision of the information to the network then indicates that the UE 110 supports the mechanism to activate/deactivate the conditional reconfigurations.

The above embodiments may be combined in any possible way, e.g., so that the UE 110 is able to determine whether to activate or deactivate a stored conditional reconfiguration upon execution of a mobility procedure based on the type of conditional reconfiguration (e.g. if it is a CHO, CPC or CPA configuration) and the target cell of the mobility procedure that is executed.

Other embodiments relate to behavior of a network node that configures an activation status of a conditional reconfiguration stored at the UE 110, wherein the activation status supports being activated and deactivated.

In some embodiments, the network node sends an indication to the UE 110 together with (e.g., within) a conditional reconfiguration, the indication indicating whether the conditional reconfiguration is to be considered to be deactivated or activated by the UE 110 upon reception of the conditional reconfiguration.

In some embodiments, the network node sends an indication to the UE 110 to consider an already stored conditional reconfiguration deactivated or activated, e.g., to deactivate a stored conditional reconfiguration that is activated or to activate a stored conditional reconfiguration that is deactivated.

In some embodiments, the network node sends the indication using dedicated or broadcast RRC signaling, MAC CE, or DCI. In one example the indication is included if the conditional reconfiguration is to be considered as deactivated whereas absence of the indication means that the conditional reconfiguration is to be considered as activated.

In some embodiments, the network node sends an indication that a certain type of conditional reconfigurations is to be considered deactivated or activated, e.g., to activate or deactivate conditional reconfigurations of that type at the UE 110. In one example, the network node sends the indication that all conditional reconfigurations of a certain type are deactivated or activated in the cell by transmitting the indication in broadcasted information (e.g., within a system information broadcast).

In the above embodiments, the network node can e.g. be an MN 120 (e.g., the serving MN 120 or a node that is included as a target MN 120 within the conditional reconfiguration) or an SN 130 (e.g., the serving SN or a node that is included as a target SN within the conditional reconfiguration). It can also be another network node where the UE 110 e.g. reads system information.

Embodiments also include methods for network nodes to configure the UE 110 with information about which conditional reconfigurations to activate/deactivate.

In some embodiments, responsive to a CPC, the MN 120 provides to each candidate T-SN 550 a list of the other candidates T-SNs and/or the other candidate PSCells (e.g., in the CG-ConfigInfo included in the S-NODE ADDITION REQUEST). In one example, the identity of one or more candidate cells is in the form of, e.g., frequency and Physical Cell Identity (PCI). In one alternative, the MN 120 only provides a list of the other candidates T-SNs and/or the other candidate PSCells that are relevant for activate/deactivate the relevant stored conditional reconfigurations after execution of a mobility procedure to that T-SN 550. In one example, the MN 120 only provides a list of the other candidates T-SNs and/or the other candidate PSCells that are relevant for activate/deactivate the relevant stored conditional reconfigurations after execution of the CPC that is being configured.

Alternatively, the MN 120 may receive information from the current serving SN 130 (corresponding to the S-SN 540 in the CPC procedure that is being configured) about the other candidate T-SNs and/or candidate PSCells, based on which the MN 120 can provide a list of other relevant candidate T-SNs and/or other relevant candidate PSCells to each candidate T-SN 550. In one example, the S-SN 540 provides this information to the MN 120 in the S-NODE CHANGE REQUIRED message that is used for configuration of the CPC procedure.

In some embodiments, the candidate T-SN 550, when receiving the S-NODE ADDITION REQUEST message, combines the received list of other candidate T-SNs and/or other candidate PSCells with other available information (e.g., neighbor cell relations towards the other candidate PSCells, connections towards the other candidate T-SNs, operator configuration) to determine which conditional reconfigurations of other candidate T-SNs/PSCells the UE 110 should store and activate or deactivate in case the UE 110 executes the mobility to the cell of the T-SN 550, e.g. in case the UE 110 executes the conditional reconfiguration (e.g. for CPC) to the PSCell 180 for which the T-SN 550 is providing the target SCG configuration.

Alternatively, the candidate T-SN 550, based on the received information, may determine whether the UE 110 shall store and activate its conditional reconfiguration, in case the UE 110 executes the mobility procedure to other candidates T-SN cells. In some embodiments, the T-SN 550 includes information to the UE 110 indicating in what other cells (e.g. target PSCells) that the UE 110 shall store and activate the conditional reconfiguration, for which the T-SN 550 is providing the target SCG configuration. For example, the T-SN 550 may include this information within the target SCG configuration that the T-SN 550 is providing for inclusion within the conditional reconfiguration (e.g. within a CPC configuration).

In another embodiment, the candidate T-SN 550 provides the information to the MN 120 together with the target SCG configuration, e.g. in the S-NODE ADDITION REQUEST ACKNOWLEDGE message. The MN 120 can then provide the information to the UE 110 within, or together with, the conditional reconfiguration (e.g. the CPC configuration) for the related candidate PSCell in the candidate T-SN 550.

In another embodiment, the candidate T-SN 550 sends the information about what conditional reconfigurations and/or candidate cells to activate or deactivate to the MN 120, by sending the execution condition with or without an associated ReportConfig/MeasObject. In one example, if there is conditional reconfiguration with execution conditions that do not have any mapping measId in the measurement configuration, then the corresponding conditional reconfiguration is deactivated. Otherwise, if there is a mapping measId, the conditional reconfiguration is activated. In another example the candidate T-SN 550 can explicitly tell if the conditional reconfiguration is activated or deactivated, by setting a specific ad-hoc indication included the conditional reconfiguration.

Alternatively, the candidate T-SN 550 may include for one or more of the conditional reconfiguration(s) to activate or deactivate, other information, e.g., the time T indicating how long to keep the conditional reconfiguration activate, or the number X of mobility procedures where the conditional reconfiguration is to be active.

In some embodiments, the MN 120 receives the list of the candidate cells and related conditional configurations to activate or deactivate from all the candidate T-SNs and sends this information to the UE 110 by including, per each conditional configuration sent to the UE 110 in the RRCReconfiguration, the execution conditions with or without an associated ReportConfig/MeasObject or the specific indication as received by the T-SNs and/or the time T indicating how long to keep the conditional reconfiguration activate, or the number X of mobility procedures where the conditional reconfiguration is to be active.

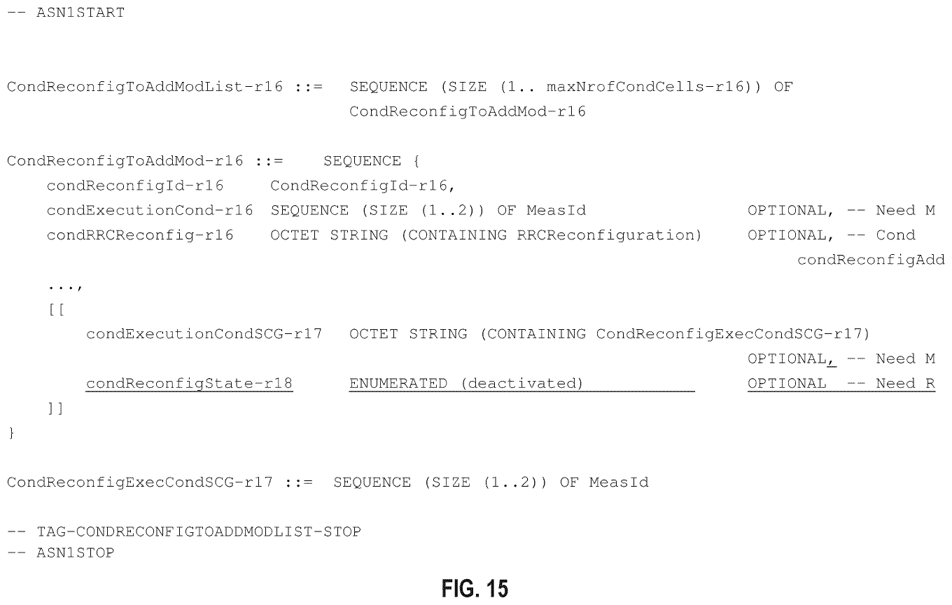

Embodiments of the present disclosure may be implemented in the RRC specification TS 38.331. An example IE definition that may be used as part of the RRC specification is the CondReconfigToAddModList IE illustrated in the ASN.1 code snippet of FIG. 15, which enables the UE 110 to activate/deactivate a conditional reconfiguration. The condReconfigState-r18 field in particular is new and indicates that conditional reconfiguration is deactivated. The absence of the field indicates that the conditional reconfiguration is activated.

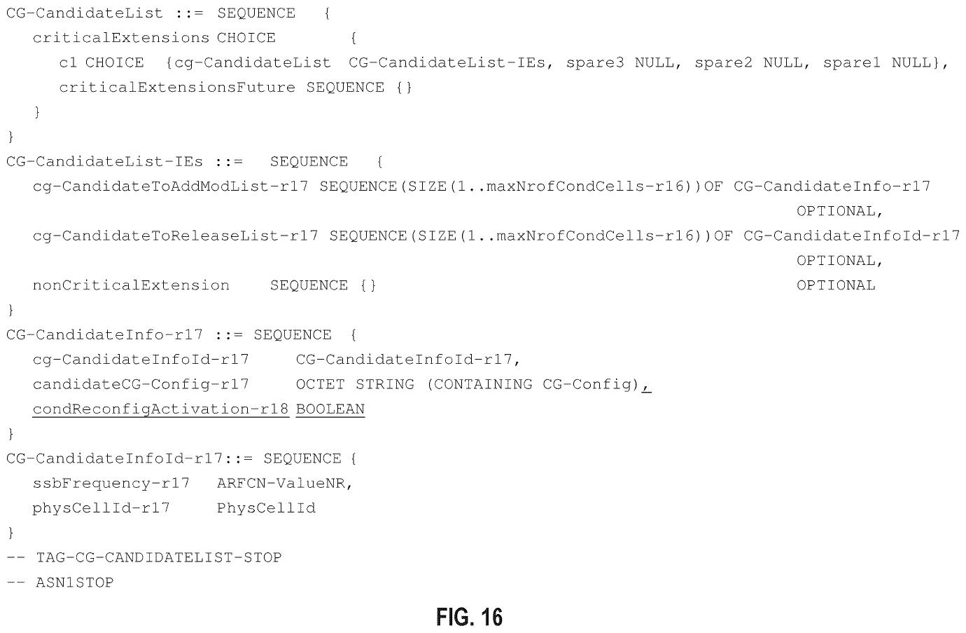

An example message definition that may be used as part of the RRC specification is the CG-CandidateList message illustrated in the ASN.1 code snippet of FIG. 16, which may be used to transfer the SCG radio configuration for one or more candidate cells for CPA or CPC as generated by the candidate target SgNB. The message is sent from the secondary gNB to the master gNB or eNB. The condReconfigActivation field indicates if the conditional reconfiguration is activated (value=true) or deactivated (value=false).

FIG. 7 illustrates an example arrangement of certain entities described above in accordance with one or more embodiments. The UE 110 is a wireless terminal (e.g., a cellular smartphone). The UE 110 is sometimes configured for multi-radio dual connectivity, MR-DC.

The UE 110 is connected via a first cell group 602 to a first network node 606 over a radio interface 604. When the UE 110 is configured in MR-DC, the UE 110 is also connected via a second cell group 603 to a second network node 607 over a radio interface 605.

The first network node 606 (e.g., an MN 120) controls the first cell group 602 (e.g., the MCG 140). The first cell group 602 is configured with a main cell (e.g., a PCell 160) and optionally multiple additional cells (e.g., SCells 170) in a CA configuration.

When the UE 110 is configured in MR-DC, the second network node 607, sometimes known as an SN 130 controls the second cell group 603, sometimes also known as the SCG 150. The second cell group 603 is configured with a main cell, such as a PSCell 180, and optionally multiple additional cells, such as SCells 170, in a CA configuration. The second network node 607 is connected with the first network node 606 over an interface 609.

The third network node 608 is in the context of a mobility procedure or a conditional configuration sometimes also referred to as a T-SN 550, a T-MN, a target gNB or a target eNB. It controls a third cell group (not illustrated in the figure), including a cell during a mobility procedure in the context of a mobility procedure or a conditional configuration sometimes referred to as a candidate target cell or a target cell. The third network node 608 is connected to the first network node the first network node 606 over an interface 610 and may also be connected to the second network node 607 over an interface 611.

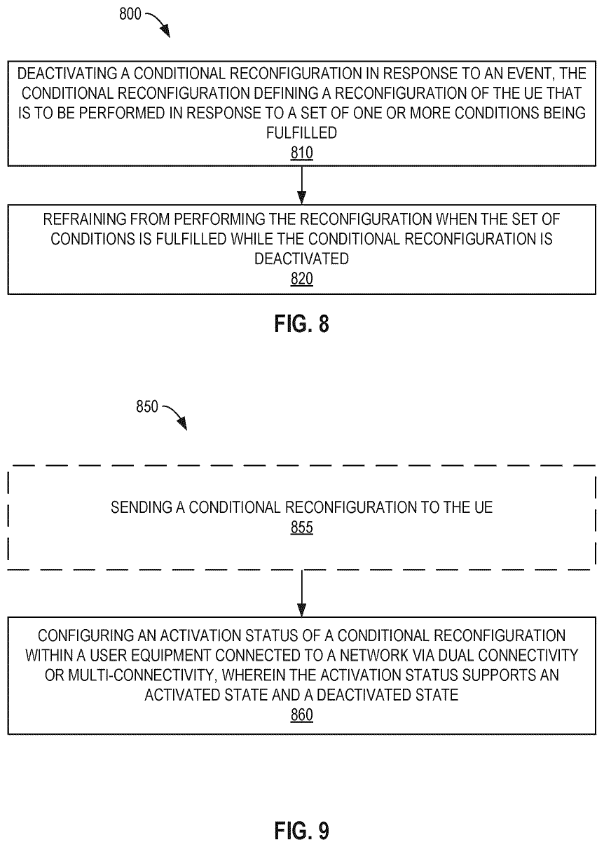

In view of the above, embodiments of the present disclosure include a method 800 performed by a UE 110 connected to a network via Dual Connectivity (DC) or Multi-Connectivity (MC), as shown in FIG. 8. The method 800 comprises deactivating a conditional reconfiguration in response to an event (block 810). The conditional reconfiguration defines a reconfiguration of the UE 110 that is to be performed in response to a set of one or more conditions being fulfilled. The method 800 further comprises refraining from performing the reconfiguration when the set of conditions is fulfilled while the conditional reconfiguration is deactivated (block 820).

Other embodiments of the present disclosure include a method 850 performed by a network node, as shown in FIG. 9. The method 850 comprises configuring an activation status of a conditional reconfiguration within a UE 110 connected to a network via DC or MC (block 860). The activation status supports an activated state and a deactivated state. In some embodiments, the method 850 further comprises sending the conditional reconfiguration to the UE 110 (block 855). The configuring of the activation status may be performed after, or along with, sending the conditional reconfiguration, depending on the embodiment.

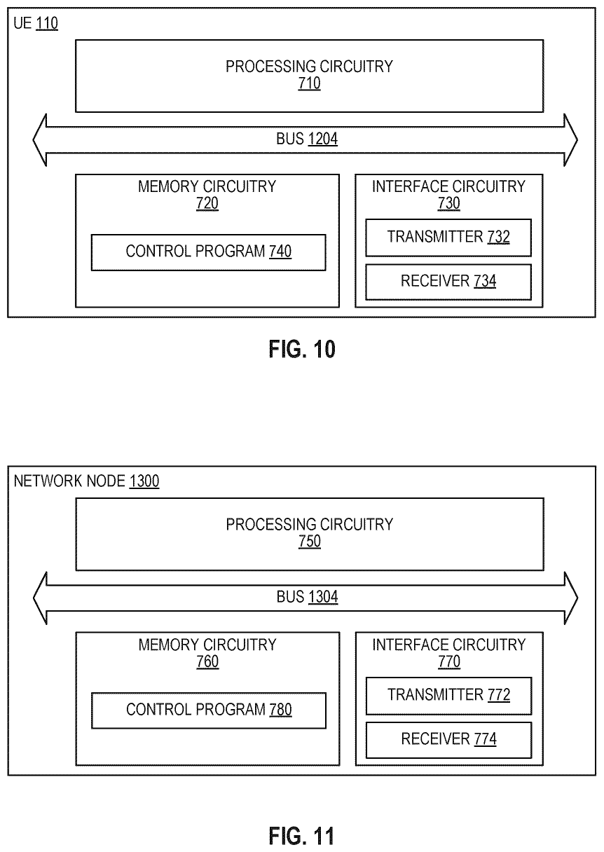

Other embodiments of the present disclosure include a UE 110 implemented as illustrated in the example of FIG. 10. The example UE 110 of FIG. 10 comprises processing circuitry 710, memory circuitry 720, and interface circuitry 730. The processing circuitry 710 is communicatively coupled to the memory circuitry 720 and the interface circuitry 730, e.g., via a bus 1204. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions stored, e.g., as a machine-readable computer program 740 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the UE 110. Such I/O data paths may include data paths for exchanging signals over a network. The interface circuitry 730 may be implemented as a unitary physical component, or as a plurality of physical components that are contiguously or separately arranged, any of which may be communicatively coupled to any other, or may communicate with any other via the processing circuitry 710. For example, the interface circuitry 730 may comprise a transmitter 732 configured to send wireless communication signals and a receiver 734 configured to receive wireless communication signals.

According to particular embodiments, the interface circuitry 730 is configured to connect to a network via DC or MC. The processing circuitry 710 is configured to deactivate a conditional reconfiguration in response to an event. The conditional reconfiguration defines a reconfiguration of the UE 110 that is to be performed in response to a set of one or more conditions being fulfilled. The processing circuitry 710 is further configured to refrain from performing the reconfiguration when the set of conditions is fulfilled while the conditional reconfiguration is deactivated.

Other embodiments include a computer program 740 comprising instructions that, when executed on processing circuitry 710 of a UE 110, cause the UE 110 to carry out the method 800.

Yet other embodiments include a carrier containing the computer program 740. The carrier is one of an electronic signal, optical signal, radio signal, or computer readable storage medium.

Other embodiments of the present disclosure include a network node 1300 implemented as illustrated in the example of FIG. 11. The example network node 1300 of FIG. 11 comprises processing circuitry 750, memory circuitry 760, and interface circuitry 770. The processing circuitry 750 is communicatively coupled to the memory circuitry 760 and the interface circuitry 770, e.g., via a bus 1304. The processing circuitry 750 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 750 may be programmable hardware capable of executing software instructions stored, e.g., as a machine-readable computer program 780 in the memory circuitry 760. The memory circuitry 760 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 770 may be a controller hub configured to control the input and output (I/O) data paths of the network node 1300. Such I/O data paths may include data paths for exchanging signals over a network. The interface circuitry 770 may be implemented as a unitary physical component, or as a plurality of physical components that are contiguously or separately arranged, any of which may be communicatively coupled to any other or may communicate with any other via the processing circuitry 750. For example, the interface circuitry 770 may comprise a transmitter 772 configured to send wireless communication signals and a receiver 734 configured to receive wireless communication signals.

According to particular embodiments, the interface circuitry 730 is configured to exchange communication signals with a UE 110. The processing circuitry 750 is configured to configure an activation status of a conditional reconfiguration within the UE 110. The UE 110 is connected to a network via DC or MC. The activation status supports an activated state and a deactivated state.

Other embodiments include a computer program 780 comprising instructions that, when executed on processing circuitry 750 of a network node 1300, cause the network node 1300 to carry out the method 850.

Yet other embodiments include a carrier containing the computer program 780. The carrier is one of an electronic signal, optical signal, radio signal, or computer readable storage medium.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry that processes information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, the devices described herein may comprise multiple different physical components that make up a single illustrated component, and functionality may be partitioned between separate components.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

The embodiments described above may, of course, be carried out in other ways than those specifically set forth herein without departing from essential characteristics of the invention. The present embodiments are to be considered in all respects as illustrative and not restrictive and all changes coming within the meaning and equivalency range of the appended claims are intended to be embraced therein.

1-40. (canceled)

41. A method performed by a User Equipment (UE) connected to a network via Dual Connectivity or Multi-Connectivity, the method comprising:
deactivating a conditional reconfiguration in response to an event, the conditional reconfiguration defining a reconfiguration of the UE that is to be performed in response to a set of one or more conditions being fulfilled, wherein the event comprises that the conditional reconfiguration is unmapped to a particular measurement configuration parameter; and
refraining from performing the reconfiguration when the set of conditions is fulfilled while the conditional reconfiguration is deactivated.

42. The method of claim 41, further comprising, responsive to deactivating the conditional reconfiguration, refraining from evaluating whether the set of conditions is fulfilled for as long as the conditional reconfiguration continues to be deactivated.

43. The method of claim 41, further comprising evaluating whether the set of conditions is fulfilled while the conditional reconfiguration is deactivated.

44. The method of claim 41, further comprising activating the conditional reconfiguration and performing the reconfiguration responsive to the set of conditions being fulfilled.

45. The method of claim 41, further comprising receiving, from the network, the conditional reconfiguration and an indication of whether to treat the conditional reconfiguration as activated or deactivated upon receipt.

46. The method of claim 41, further comprising switching an activation state of the conditional reconfiguration depending on whether or not an indication from the network is present, where switching the activation state comprises switching between an activated state and a deactivated state.

47. The method of claim 41, further comprising:
receiving, from the network, a configuration message comprising a type and a state, the state being either activated or deactivated; and
setting, for one or more conditional reconfigurations stored at the UE, each of the conditional reconfigurations that matches the type to the state comprised in the configuration message.

48. A method performed by a network node, the method comprising:
configuring an activation status of a conditional reconfiguration within a User Equipment (UE) connected to a network via Dual Connectivity or Multi-Connectivity, wherein configuring the activation status comprises sending an indication of the activation status to the UE; and
sending the indication of the activation status comprises sending the conditional reconfiguration to the UE with an unmapped measurement configuration parameter, the unmapped measurement configuration parameter indicating that the activation state is the deactivated state;
wherein the activation status supports an activated state and a deactivated state.

49. The method of claim 48, wherein sending the indication of the activation status to the UE comprises sending the indication to the UE while the conditional reconfiguration is already stored at the UE.

50. The method of claim 48, wherein sending the indication of the activation status to the UE comprises sending the indication along with the conditional reconfiguration.

51. The method of claim 48, wherein configuring the activation status comprises changing the activation status of the conditional reconfiguration.

52. The method of claim 48, wherein sending the indication of the activation status comprises sending the conditional reconfiguration to the UE with a valid measurement configuration parameter, the valid measurement configuration parameter indicating that the activation state is the activated state.

53. A User Equipment (UE) comprising:
interface circuitry configured to connect to a network via Dual Connectivity or Multi-Connectivity; and
processing circuitry configured to:
deactivate a conditional reconfiguration in response to an event, the conditional reconfiguration defining a reconfiguration of the UE that is to be performed in response to a set of one or more conditions being fulfilled, wherein the event comprises that the conditional reconfiguration is unmapped to a particular measurement configuration parameter; and
refrain from performing the reconfiguration when the set of conditions is fulfilled while the conditional reconfiguration is deactivated.

54. The UE of claim 53, wherein the processing circuitry is further configured to, responsive to deactivating the conditional reconfiguration, refrain from evaluating whether the set of conditions is fulfilled for as long as the conditional reconfiguration continues to be deactivated.

55. The UE of claim 53, wherein the processing circuitry is further configured to evaluate whether the set of conditions is fulfilled while the conditional reconfiguration is deactivated.

56. The UE of claim 53, wherein the processing circuitry is further configured to activate the conditional reconfiguration and perform the reconfiguration responsive to the set of conditions being fulfilled.

57. A network node comprising:
interface circuitry configured to exchange communication signals with a User Equipment (UE), wherein the UE is connected to a network via Dual Connectivity or Multi-Connectivity; and
processing circuitry configured to:
configure an activation status of a conditional reconfiguration within the UE, the activation status supporting an activated state and a deactivated state, wherein configuring the activation status comprises sending an indication of the activation status to the UE; and
send the indication of the activation status comprises sending the conditional reconfiguration to the UE with an unmapped measurement configuration parameter, the unmapped measurement configuration parameter indicating that the activation state is the deactivated state.

58. The network node of claim 57, wherein to send the indication of the activation status to the UE the processing circuitry is configured to send the indication to the UE while the conditional reconfiguration is already stored at the UE.

59. The network node of claim 57, wherein to send the indication of the activation status to the UE the processing circuitry is configured to send the indication along with the conditional reconfiguration.

60. The network node of claim 57, wherein to configure the activation status the processing circuitry is configured to change the activation status of the conditional reconfiguration.
